(19) United States
(12) Patent Application Publication
(10) Pub. No.: US 2006/0259242 A1
(43) Pub. Date: Nov. 16, 2006

(54) Localized key numbering for maps and charts

(76) Inventor: Weiping Yang, West Windsor, NJ (US)

Correspondence Address: Arthur M. Peslak, Esq.;MANDEL & PESLAK, LLC, Suite 5, 80 Scenic Drive, Freehold, NJ, 07728, US

(21) Appl. No.: 11/084,874

(22) Filed: May 11, 2005

(51) Int. Cl. G06F 19/00

(52) U.S. Cl. 702/5

(57) ABSTRACT

A method and software for the cartographically meaningful localized placement of Key Numbers and corresponding Key Reference Tables on cartographic maps or charts is disclosed. An interactive automated method for determining when and how Key Numbers and corresponding names should be placed in a localized reference table is disclosed. The result of the current invention is an aesthetic, conflict-free, and cartographically informative placement of textual information on a map or chart.

### FIELD OF THE INVENTION

This invention relates to the computation and cartographically informative placement of key numbers on a cartographic map or chart. In particular, the invention provides an automated method of determining when a cartographic name cannot be placed on the map according to the specified placement criteria, and should instead be represented as a key number, with the key number and the corresponding name placed in one or more reference tables. The automated methods based on this invention may be used in connection with Geographic Information Systems (GIS).

### BACKGROUND OF THE INVENTION

1. The Context of the Invention

In labeling cartographic features in connection with a GIS (Geographic Information System), it is sometimes impossible to place the full name (or label) of a feature without the name overlapping other features and labels. This is cartographically undesirable and should be avoided. In such cases, a cartographically accepted solution is to use a short key symbol (a positive integer 1, 2, 3, . . . and hence called “key number”) to represent the feature's name in a reference table.

Until recently, key numbers and reference tables have been largely generated and placed manually. When key numbers are placed manually for their associated features, one or more reference tables need to be constructed and placed either in the margin of the map or near the clusters of neighboring features for which key numbers are present. The manual key numbering process is tedious, extremely time-consuming, and costly. It was improved in recent years by an automated method developed by MapText, Inc., which has been implemented in the flagship product called Label-EZ™. The method uses a global key numbering system for the entire map in which the key numbers are spatially ordered and automatically placed for their corresponding features. The system generates reference files that list the key numbers together with the corresponding feature names. However, cartographers still have to create manually the reference tables in a GIS environment and manually position the tables on the map. This manual process requires careful matching of key numbers and feature names, and creating tables with due regard to the margin space or available spaces near clusters of keynumbered features.

The method and software tool of the present invention is directed to aiding cartographers to key-number selected features, and automatically generate local reference tables that can be easily placed in the vicinity of each selection. The method is interactive so that cartographers can customize the output to achieve exactly what they want. The key numbers within each reference table are localized and ordered against selected locations to facilitate matching key numbers to their corresponding features. This process is illustrated in FIGS. 8-10.

2. Prior Art

The invention is designed to be used within the framework of MapText Inc.'s automated label placement software packages, Label-EZ™ and Label-Edit™. Both software packages are widely used within a GIS environment to automate label placement for cartographic maps and nautical and aeronautical charts. Prior to the present invention, key numbers were placed and spatially ordered by Label-EZ™ across the entire map, and one or more key number reference files were generated and saved. There were the following disadvantages with this method:
The key numbers tend to get large (more than two digits), especially for large and dense maps, making them difficult to place.
The key numbers refer to features across the entire map, and, therefore, matching key numbers with the full names required searching through the entire map.
Within a GIS it is not easy to generate key reference tables that only refer to the names of features within certain designated areas (localized tables).

It is well-known to those of ordinary skill in the art of cartography that localized key numbers and reference tables are typically labeled through tedious manual work within a GIS platform. Prior to the present invention, there have been no automated methods or software available for this process.

3. Objectives of the Invention

The present invention is directed to an interactive method to place and spatially order key numbers within a designated area so that they can be unambiguously identified by a table referring to the features names. The table should be generated automatically by the method (and the software) and interactively placed near the designated area by the user. The development of the software tool based on the method has the following objectives:
1. The software tool should facilitate the selection of designated areas within which features to be key numbered can be identified and grouped together.
2. It should be possible to modify the designated area to exclude or include features.
3. There should be a provision for choosing the starting key number, with the rest of the key numbers within the group successively augmented by one (1).
4. The key numbers within the group should be spatially ordered.
5. It should be possible to convert a key number into its original label and vice versa.
6. Once key numbers are created for a selected group, a key reference table should be automatically generated, including all corresponding key numbers and labels.
7. The user should be able to position the key reference table at the location of his/her choice (usually near the location of the keynumbered feature group).
8. Users should be able to manipulate the key reference tables, e.g., change the font size, style, color, or choose the number of columns for the table.

### SUMMARY OF THE INVENTION

The present invention is directed to an interactive tool that allows cartographers heuristically to place localized key numbers and their corresponding reference tables on cartographic maps and charts. The invention helps speed up the process of high-quality text placement for keynumbered features, which is otherwise difficult and time-consuming.

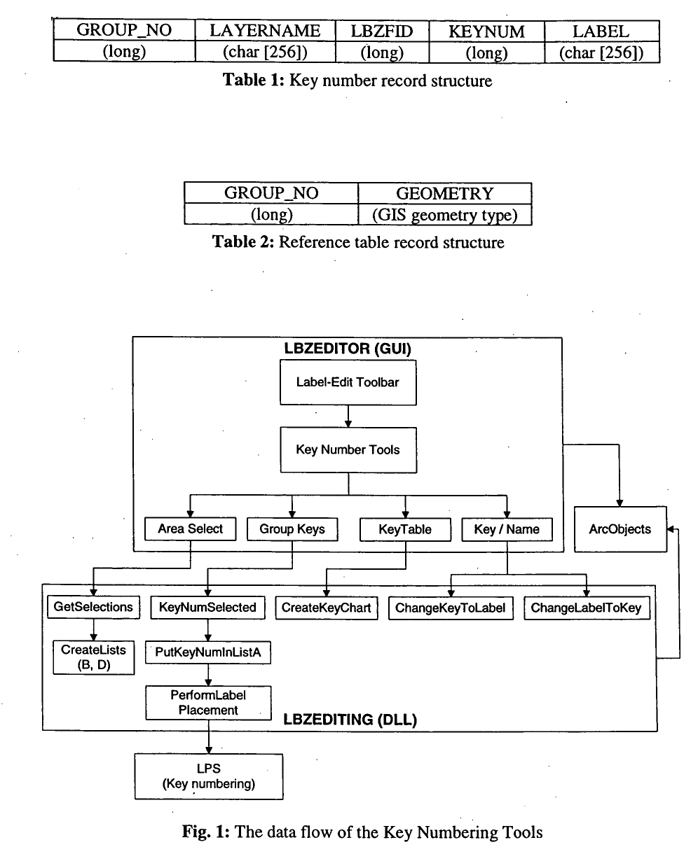

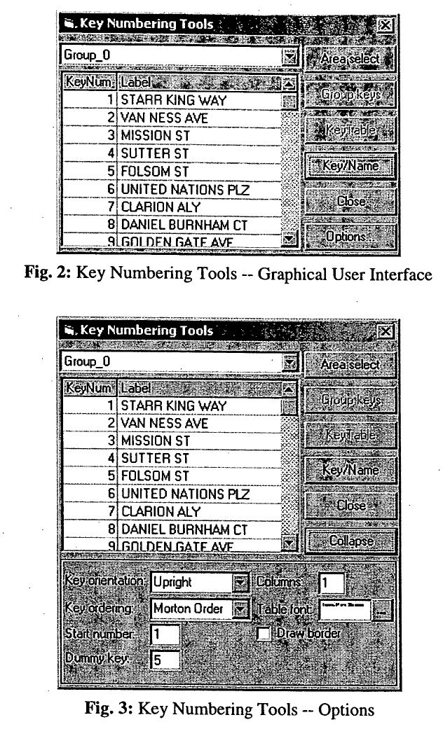

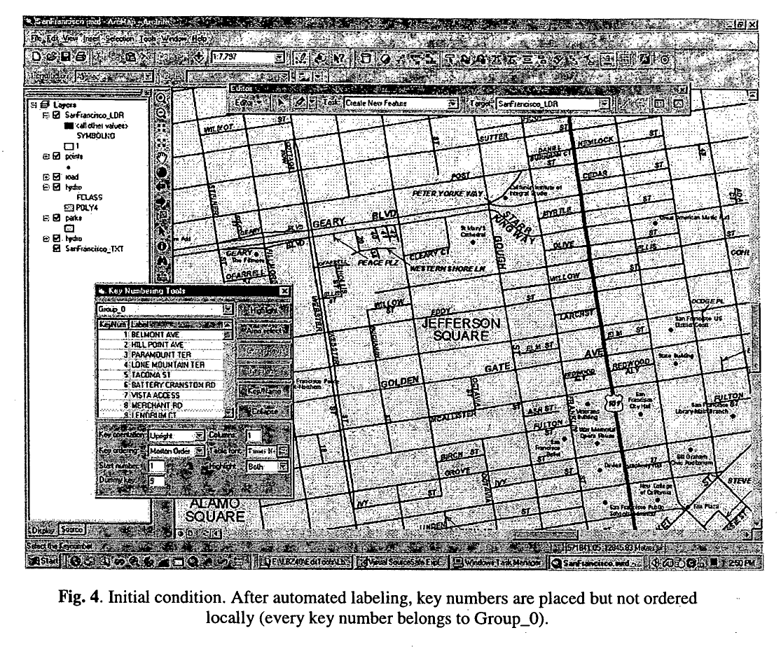

The interactive tool is built into Label-Edit™, a collection of interactive editing tools, and works within a GIS. The data flow of the tool is illustrated in FIG. 1. FIGS. 2 and 3 show the tool's graphical user interface (GUI). The interactive tool is dependent on Label-EZ™ having processed label placement for the map features, some of which may not have normal labels placed due to insufficient space. While preparing the rules for running Label-EZ™, users can specify that a temporary key number be placed in lieu of the full label when sufficient space is not available. Alternatively, users can simply choose to suppress the label entirely if it cannot be placed. In either case, the placement status for all features will be recorded in a table created by Label-EZ™. As illustrated in FIG. 4, the placement output can then be displayed with a GIS on top of other map layers and edited using Label-Edit™.

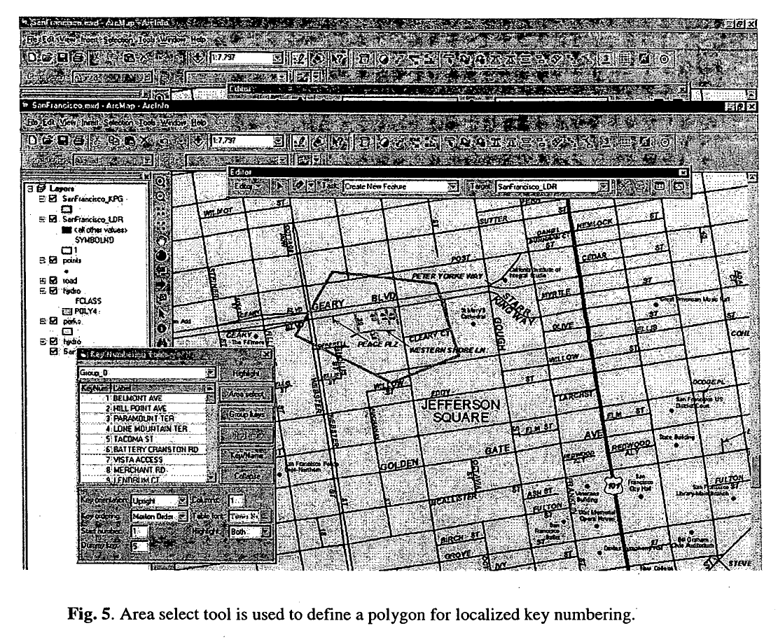

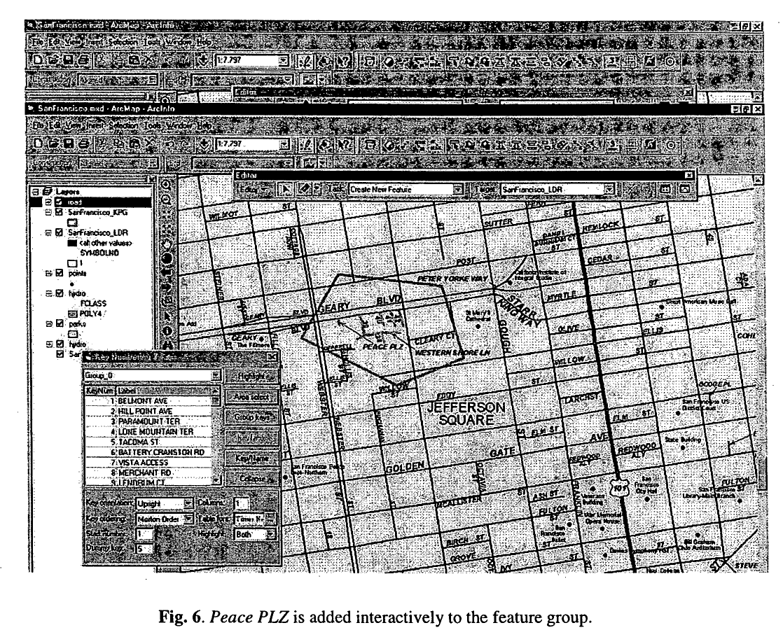

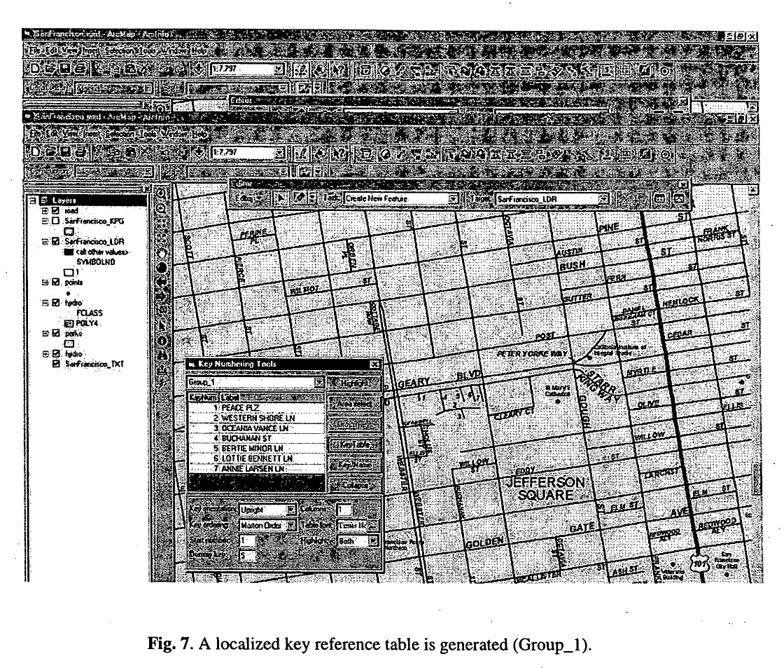

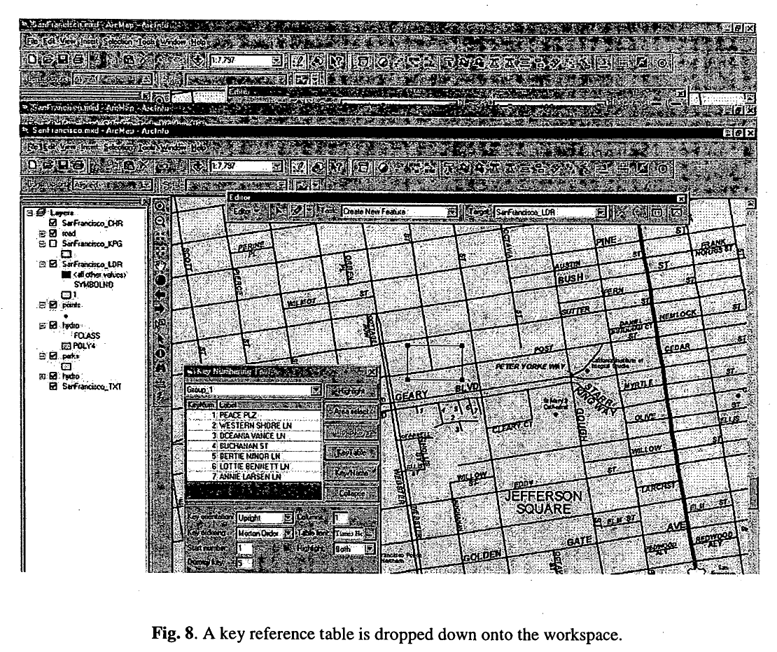

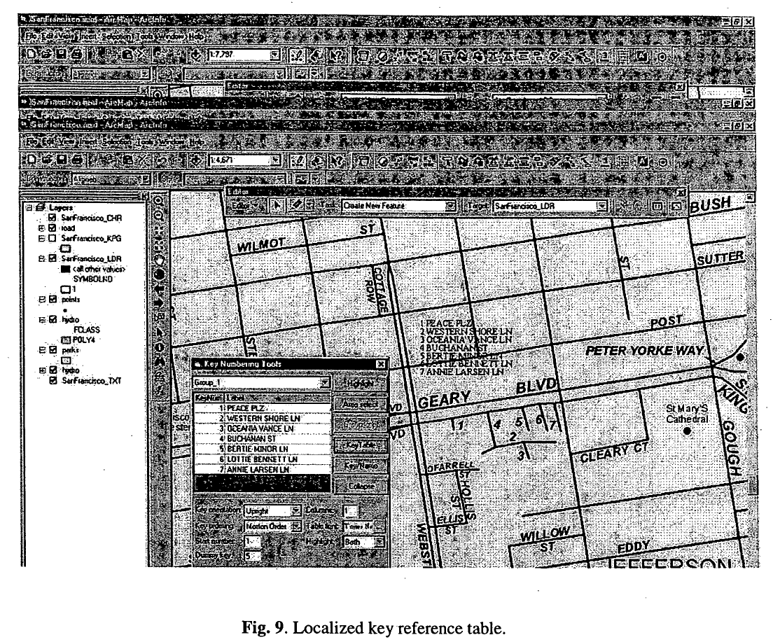

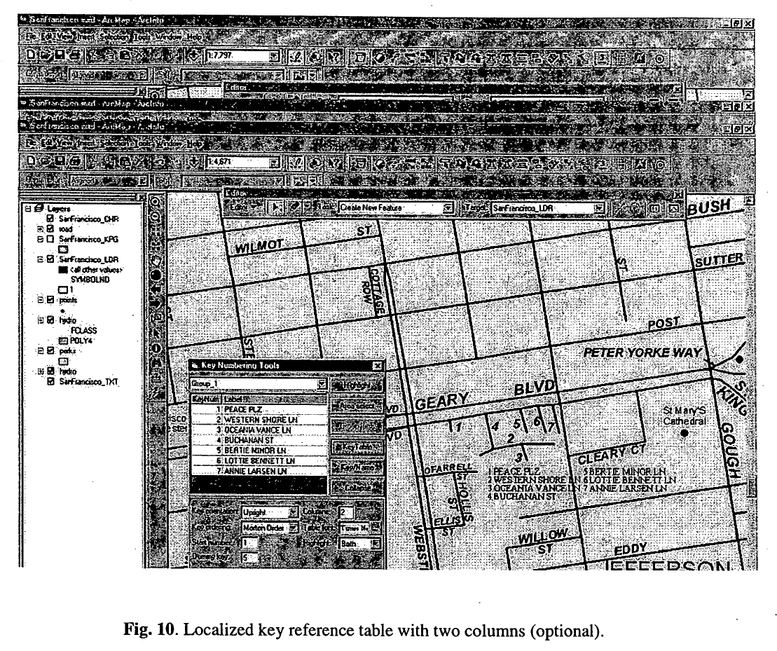

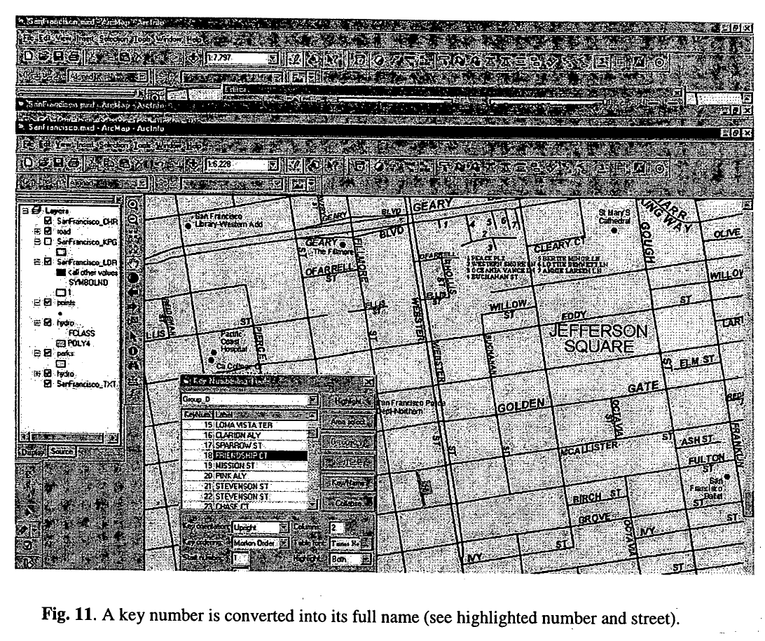

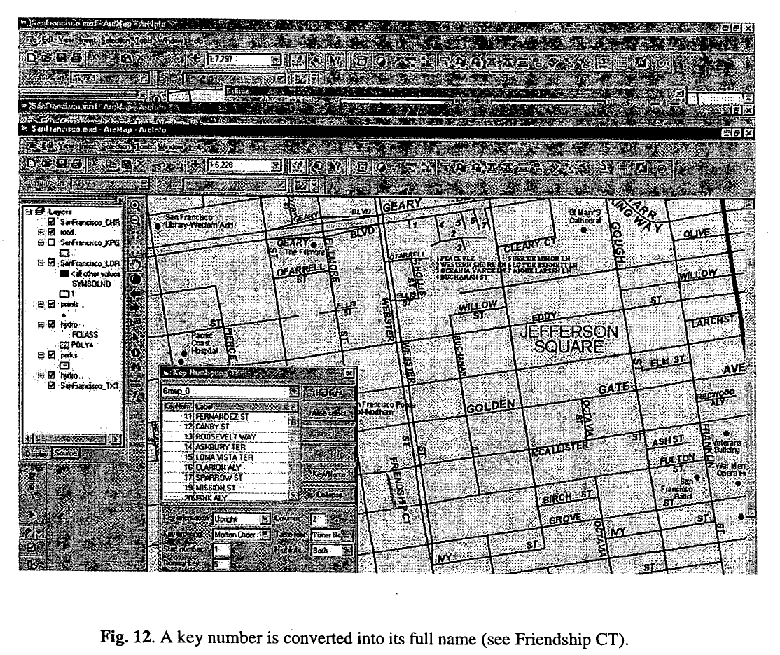

Before localized key numbers are generated and placed, users must identify a group of features for which key numbers are to be placed. This can be done by using the “Area select” command which allows users to draw a closed polygon of any shape to be used as the spatial filter. This is illustrated in FIG. 5. An SQL statement is then internally prepared with the spatial filter and other criteria of the users' choice. The criteria may be targeted to features which are placed with temporary key numbers or whose labels are suppressed, or both. The search result will be highlighted on the screen. Users can also interactively add features to the group such as is shown in FIG. 6. With features highlighted, users can use the “Group keys” command to place key numbers for the features that will be spatially ordered. The command also groups the key numbers with their original names and makes the group available for selection shown in FIG. 7. While selecting a key group, users can issue the “Key table” command to generate a bounding rectangle of the key reference table for the key group which users can then move and position at a desired location in the proximity of the key group shown in FIG. 8. Upon being positioned, the key table will be displayed with the user-selected font, font size, color, and the number of columns (as shown in FIGS. 9 and 10). Users can also modify any existing key groups by altering the shape of the delimiting polygon, by highlighting or de-highlighting features, or by changing the placement status by using the “Key/Name” command. A key number can also be converted to its corresponding name by the user as shown in FIGS. 11 and 12.

### BRIEF DESCRIPTION OF THE DRAWINGS

Illustrate the data flow of the Key Numbering Tools of the
present invention.
Illustrates the graphical user interface (GUI) for the Key
Numbering Tools of the present invention.
Illustrates the GUI for selecting the option for the Key
Numbering Tools of the present invention.
Illustrates the software tool's initial condition. After
automated labeling, key numbers are placed but not ordered
locally (every key number belongs to Group_0.
Illustrates the area select tool which is used to define a
polygon for localized key numbering.
Illustrates the Peace PLZ as added interactively to the
feature group.
Illustrates a localized key reference table as generated.
(Group_1)
Illustrates a key reference table as dropped down onto the
workspace.
Illustrates a localized key reference table.
Illustrates a localized key reference table with two columns
(optional).
Illustrates how a key number is converted into its full name
(see highlighted number and street).
Illustrates how a key number is converted into its full name
(se Friendship CT)..

### DETAILED DESCRIPTION OF THE INVENTION

1 Interfacing Label-EZ™

When users intend to use key numbering tools to edit localized key numbers, they will have two choices for running Label-EZ™: (1) do not specify any KEYNUM execution keyword in the placement sequence and use SUPPRESS as the failure keyword, or (2) specify a KEYNUM keyword in the execution sequence for place holding with a constant temporary key number of a given digit length.

For the first choice, key numbers will not be presented when placement results are displayed. Users can pan over the map and look for areas where localized key numbers will be generated. The search is aided by highlighting features for which the labels were suppressed.

For the second choice, temporary key numbers will be displayed in the GIS, which is helpful for the user to spot clusters of key numbers for which localized key numbers can be appropriately assigned in place of the temporary key numbers.

TABLE 1
Key Number Record Structure

| GROUP_NO | LAYERNAME | LBZFID | KEYNUM | LABEL |
|---|---|---|---|---|
| (long) | (char[256]) | (long) | (long) | (char [256]) |

TABLE 2
Reference Table Record Structure

| GROUP_NO | GEOMETRY |
|---|---|
| (long) | (GIS geometry type) |

The changes to Label-EZ™ are the following:
One new table, KeyTable, recording all key numbers is added to the output source from the GISInterface module in Label-EZ™, in the back-end process. The structure of the table is shown in Table 1.
One new feature class, KeyPolygonFeatureClass, for the key-number-selecting polygons is created and added to the output source from GISInterface, in the back-end process. The structure of the table representing the feature class is shown in Table 2.

2 Interactive Key Numbering Tools

The Key Number Tools in Label-Edit™ handle the following scenarios with corresponding functions:
Area Select. The user draws a polygon delimiting features as illustrated in FIG. 5. Upon completing the polygon, those features whose labels are suppressed or key-numbered will be selected and highlighted. At the same time, two lists are created: ListB, composed of all features within or intersecting the selection polygon, and ListD, composed of all text labels within or intersecting the selection polygon.
Group Keys. After a list of features (or text labels) has been selected, the user can invoke this tool to generate localized and spatially ordered key numbers in this selection group. This is done by invoking the KeyNumSelected DLL function which will first create ListA by validating the selection. Any features included in ListA will be excluded from ListD. After all ListA items are created, KeyNumSelected will invoke PutKeyNumInListA to order ListA features by a user-selected spatial ordering scheme. The centers of the bounding boxes of ListA features are used for the spatial ordering. At the end of the ordering, key numbers will be assigned to the text field of each ListA member. After this, the PerformLabelPlacement function will be called with Lists A, B, and D as input parameters. PerfomiLabelPlacement will load a dll called LPS DLLs for placing key numbers. The result of the placement will be recorded by KeyNumSelected by modifying the KeyTable with information fed back from ListA. When placement is complete, Group Keys will perform a query to the KeyTable and list the result in a box in Key Number Tools.
Key Table. As shown in FIG. 9, once a key number group is listed in Key Number Tools, the user can invoke the tool to generate a key table for this group. The tool firstly computes the size of the box based on the list of labels and font parameters. The boundary of the box is then passed to CreateKeyChart DLL function to fill annotation graphics of the labels within the boundary.
Key/Name. This tool is implemented with the support of the ChangeKeyToLabel and ChangeLabelToKey DLL functions. Both functions will query the Txt feature class for the feature whose label is to be changed. For ChangeKeyToLabel, the corresponding record in the Key table is queried to obtain the original label and the first annotation element is replaced with the full name. For ChangeLabelToKey, the text field of the annotation elements of the feature is accessed to assemble the original label, and the first text annotation element is filled with the key number text. The position of the key number is computed based on the text angle and original annotation placement positions. In both cases, any additional annotation elements after the first one will be deleted.

3 The Methods

After running Label-EZ™, users can display the original map generated by Label-EZ™ together with the label placement result on the GIS screen. They would then examine the map for congested areas where labels were either suppressed or replaced by temporary key numbers. With the Key Number Tool displayed in the Label-Edit™ tool bar, users can create groups of key numbers and generate reference tables in the vicinity of the respective groups.

3.1 Grouping Features to be Key-Numbered

For grouping, a user must first navigate (pan and zoom) to an area to be considered for grouped key numbering. The area should then be shifted so that the area will be in the approximate center of the computer screen. By selecting the Area Select command button from the Label-Edit™ tool bar, the mouse-cursor will now be changed from an arrow to a cross. The user must then move the cursor to any start location for the enclosing polygon and click the left button to start generating the delimiting polygon. Upon clicking the left button, a line will be drawn between the clicked vertex and the moving cursor, which shows the user where the boundary line can be located. Continued clicking on desired locations for more boundary vertices will define the polygon boundary. After the last vertex has been generated by left-clicking, the user should click the right button to terminate the polygon definition. The polygon will then be closed automatically by a line segment from the last to the first vertex. Upon completing this selection, all features contained or partially contained within the polygon, whose labels were either suppressed or temporarily key-numbered, will be selected and highlighted. The highlighted features will be used to form a key group. The user can then select or de-select any features within this group by pressing the Ctrl key while clicking on a desired feature.

3.2 Generating Localized Key Numbers

With features selected (highlighted), the user can click the Group Keys command button to start the key numbering process. This will accomplish the following:
Send the list of selected features to the DLL functions for assigning a unique number to each selected feature. The starting number is taken from what was specified in the Key Numbering Tool option window. The rest of the numbers are then successively incremented by one from the previous key number. The key numbers are assigned in a spatially ordered fashion based on the locations of the centers of the bounding boxes of the respective feature labels. The spatial ordering scheme is specified by the user. The ordering is performed by a DLL function.
The assigned key numbers are then placed near their respective features by invoking the placement-engine DLL functions. This is done in the same manner as when placing normal names of map features. If a key number cannot be placed due to space limitations, the number will be assigned to the next feature in the list.
After placement, the key numbers of the group, together with their associated full names, will be displayed in the grid area of the Key Numbering Tools window. Clicking on a row in the grid will highlight the corresponding feature on the map. The key number group is identified by a group number shown in the combo box located above the grid.

3.3 Generating and Placing the Reference Table

A user can quickly display a different group of key numbers by using the drop-down menu of the combo box and selecting a group number. Upon completing the selection, the map will be re-centered.

The user can display a reference table at a location around the key group by clicking the Key Table command button to bring up the outline of the reference table, the lower left corner of which is dynamically linked to the mouse cursor. While moving the cursor, the outline box follows. Once the user has located a position for the outline box, he/she should click the left mouse button to drop the outline box on the map. Upon dropping, the outline box will be replaced by the actual reference table for the key group. The number of columns of the reference table can be specified by the user through the Key Numbering Tool window, and the size of the reference table is computed by DLL functions according to the number of columns, font style, and font size. The reference table can be selected, moved, deleted, and re-generated.

3.4 Editing Key Numbers

If desired, a user can interactively change a key number to display its full name, and vice versa. Users first select the key number or the full name of a feature, and then click on the Key/Name command button to complete the change. When a key number is replaced by its full name, it will be removed from the key group where it is located. Accordingly, when a full name is changed to a key number, it will be inserted as a new entry into the key group.

What is claimed is:

1. A computer software implemented method of grouping features on a cartographic map to be key-numbered comprising the following steps:
a. Drawing an enclosing irregular polygon on an area of the cartographic map to delimit a plurality of cartographic features; and
b. Selecting a set of the plurality of cartographic features to create a feature group of said features using a spatial filter.

2. The method of claim 1 comprising the additional step of interactively adding and removing features to and from the feature group.

3. The method of claim 2 comprising the additional steps of assigning localized key numbers for the selected cartographic features by:
a. Automatically assigning key numbers to the selected features; and
b. Automatically ordering the key numbers with a designated scheme.

4. The method of claim 3 comprising the additional steps of:
a. Interactively converting labels placed within the polygon into key numbers;
b. Nullifying the result of the placement for one of the selected features; and
c. Adding the feature into the group.

5. A computer software implemented method for automatically generating a reference table for each group of selected cartographic features comprising the following steps:
a. Accessing the key numbers and corresponding feature names within a group; and
b. Computing the dimensions of the reference table, taking due account of the number of columns and rows, as well as the font style and the font size;

6. The method of claim 5 comprising the further steps of:
a. Placing and re-locating the reference table interactively if so desired by the user; and
b. Creating the annotations of the table and making the table identifiable, selectable, and movable as a whole.
